(19) United States
(12) Patent Application Publication
(10) Pub. No.: US 2019/0187251 A1
(43) Pub. Date: Jun. 20, 2019

(54) SYSTEMS AND METHODS FOR IMPROVING RADAR OUTPUT

(71) Applicant: Vathys, Inc., Portland, OR (US)

(72) Inventor: Tapabrata GHOSH, Portland, OR (US)

(21) Appl. No.: 16/220,422

(22) Filed: Dec. 14, 2018

Related U.S. Application Data
(60) Provisional application No. 62/599,004, filed on Dec. 14, 2017.

(51) Int. Cl. G01S 7/41; G06N 3/08; G01S 13/93; G01S 13/08

(52) U.S. Cl. CPC G01S 7/417; G01S 13/08; G01S 13/931; G06N 3/08

(57) ABSTRACT

Radar is playing an increasingly important role in autonomous systems, including autonomous vehicles. However, the cost of radar systems and low output quality (e.g., resolution, accuracy and/or smoothness) are factors limiting the adoption and utility of radar systems. Disclosed are methods and devices to use machine learning models to increase the quality of the output of a radar system.

### CROSS-REFERENCE TO RELATED APPLICATIONS

This application claims the benefit of priority of U.S. Provisional Application No. 62/599,004 filed on Dec. 14, 2017 entitled “A Method of Producing High Quality Radar Outputs,” content of which is incorporated herein by reference in its entirety and should be considered a part of this specification.

### BACKGROUND

### Field of the Invention

This invention relates generally to the field of radars using electromagnetic radiation and more particularly to methods and devices for improving the output of such radar systems.

### Description of the Related Art

Higher quality radar output (e.g., higher resolution, higher accuracy, and/or other improved metrics or qualities) is generally desirable in many systems. Existing radar systems have primarily focused on improving output by improving data collection capabilities and hardware features. Examples of existing radar technology includes radars using electromagnetic radiation (e.g., radio waves, microwaves, GHz band radars), mechanical radars, radars using optical phased arrays, mirror galvanometer driven radars, flash radars and MEMs radars. Consequently, there is a need for radar systems with improved hardware and software capability to collect and output radar data.

### SUMMARY

In one aspect of the invention a method of producing an output in a radar system is disclosed. The method includes: transmitting electromagnetic waves toward a target, wherein the transmitted electromagnetic waves comprise a first dataset; sensing reflected electromagnetic waves from the target, wherein the reflected electromagnetic waves comprise a second dataset; performing machine learning operations on the first and second datasets to produce a first output, wherein the first output comprises distance information relative to the target.

In one embodiment, the output of the radar system comprises the first output.

In another embodiment, the first output comprises a point cloud, machine learning comprises one or more neural networks and the machine learning operations comprise one or more of increasing resolution, accuracy, and smoothness of the point cloud.

In some embodiments, the neural networks comprise one or more of convolutional neural network, generative adversarial network, and variational autoencoder.

In one embodiment, the machine learning operations are configured to reduce noise in the second dataset.

In some embodiments, the method further includes performing second machine learning operations on the first output to produce a second output, wherein the second output comprises distance information relative to the target.

In one embodiment, the output of the radar system comprises the second output.

In some embodiments, machine learning comprises one or more neural networks, the first machine learning operation comprises generating a point cloud and the second machine learning operation comprises refining resolution of the point cloud.

In one embodiment, the machine learning operations are configured to reduce noise in the second dataset.

In another embodiment, the method further includes training one or more machine learning models to improve one or more characteristics of the first output.

In another aspect of the invention, a radar system is disclosed. The radar system includes: an electromagnetic emitter source configured to transmit electromagnetic waves toward a target, wherein the transmitted electromagnetic waves comprise a first dataset; an electromagnetic sensor configured to detect reflected electromagnetic waves from the target, wherein the reflected electromagnetic waves comprise a second dataset; a machine learning processor configured to perform machine learning operations on the first and second datasets to produce a first output, wherein the first output comprises distance information relative to the target.

In another embodiment, an output of the radar system comprises the first output.

In one embodiment, the first output comprises a point cloud, the machine learning comprises one or more neural networks and the machine learning operations comprise increasing resolution of the point cloud.

In some embodiments, the neural networks comprise one or more of convolutional neural network, generative adversarial network, and variational autoencoder.

In one embodiment, the machine learning operations comprise reducing noise in the second dataset.

In another embodiment, the machine learning processor is further configured to perform second machine learning operations to produce a second output, wherein the second output comprises distance information relative to the target.

In some embodiments, an output of the radar system comprises the second output.

In one embodiment, machine learning comprises one or more neural networks, the first machine learning operations comprise generating a point cloud and the second machine learning operations comprise one or more of increasing resolution, accuracy and smoothness of the point cloud.

In some embodiments, the machine learning operations comprise reducing noise in the second dataset.

In another embodiment, the machine learning processor is further configured to train one or more machine learning models.

### BRIEF DESCRIPTION OF THE DRAWINGS

These drawings and the associated description herein are provided to illustrate specific embodiments of the invention and are not intended to be limiting.

FIG. 1 illustrates an example of a radar system according to an embodiment.

FIG. 2 illustrates an example radar data processing flow according to an embodiment.

FIG. 3 illustrates an example application of the disclosed radar system and data processing.

### DETAILED DESCRIPTION

The following detailed description of certain embodiments presents various descriptions of specific embodiments of the invention. However, the invention can be embodied in a multitude of different ways as defined and covered by the claims. In this description, reference is made to the drawings where like reference numerals may indicate identical or functionally similar elements.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this section prevail. When the terms “one”, “a” or “an” are used in the disclosure, they mean “at least one” or “one or more”, unless otherwise indicated.

Radar systems are used heavily in a variety of applications to measure distance, detect objects, aid in automation or other tasks. For example, radars play an important role in the self-driving, autonomous vehicle industry. Generally, radar systems operate by illuminating a target with a signal and detecting the return or reflected signal. Radar systems use transmitters and detectors to send and receive signals. Datasets from the transmitters and detectors are used to generate an output of the radar system. The output of a radar system can subsequently be analyzed and processed by other systems and components to aid in their functionality. For example, an output of a radar system in an autonomous self-driving vehicle can be used to scan a field around an autonomous vehicle, detect and/classify moving or stationary objects, avoid collision or other tasks. The choice of transmitter and detector in a radar system depends on the radar technology used. For example, some radar systems operate by sending a laser wave and detecting the return or reflected laser wave. Other radar systems utilize sound waves and analyze the return or reflected sound waves. Some radars transmit or emit electromagnetic waves and detect the return or reflected electromagnetic waves.

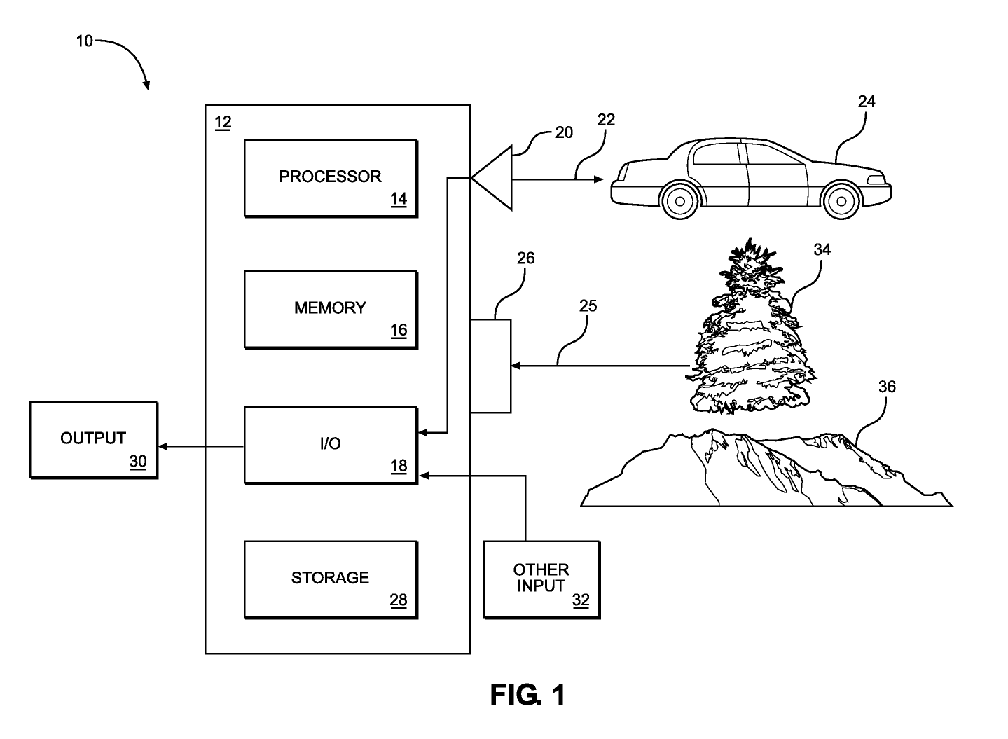

FIG. 1 illustrates a block diagram of a radar system 10 according to an embodiment. The radar system 10 can be implemented in a vehicle, an airplane, a helicopter, or other vessel where depth maps can be used to perform passive terrain surveys or used to augment a driver/operator ability or used in autonomous operation of the vessel, for example in self-driving algorithms. The radar system 10 can include a processor 14, a memory 16, input/output devices/interfaces 18 and storage 28. The radar system 10 can include an emitter 20 transmitting electromagnetic waves 22 toward one or more targets 24, 34, 36. The transmitted electromagnetic waves 22 will reflect back from the targets 24, 34, 36 via reflected electromagnetic waves 25 and are detected by a sensor 26. Emitter 22 and sensor 26 can respectively transmit and detect electromagnetic waves toward targets within a 3D space surrounding of the radar system 10. In other words, the targets 24, 34 and 36 can be in range, whether behind, below, above or in front of a vessel 12 deploying the radar system 10.

In one embodiment, the emitter 20 can include a transmitter configured to generate electromagnetic waves. In some embodiments, the emitter 20 can include an antenna which produces electromagnetic waves when excited by an alternating current. The emitter 20 can additionally or instead include components such as power supplies, oscillators, modulators, amplifiers tuner circuits, MEMs devices, micro motors and/or other components to enable generation and transmission of electromagnetic waves.

Emitter 20 can also include controllers, processors, memory, storage or other features to control the operations of the emitter 20. The emitter 20 and associated controllers generate a transmitted signal dataset, which can include raw data regarding the transmitted waves 22, such as timing, frequency, wavelength, intensity, power and/or other data concerning the circumstances and environment of the transmitted waves 22.

The transmitted signal dataset can include additional data, obtained from other sensors and detectors of the vessel 12. Such additional data can include, Global Positioning Signal data (GPS) (e.g., GPS coordinates) of the emitter 20, accelerometer data, speedometer data, inertial guidance/measurement system data, gyroscope data, gyrocompasses data and/or other associated data.

The described components and functions are example implementations. Persons of ordinary skill in the art can envision alternative radar systems, without departing from the described technology. For example, some components can be combined and/or some functionality can be performed and implemented elsewhere in the alternative system compared to those described in the radar system 10. Some functionality can be implemented in hardware and/or software.

The processor 14 can be a machine learning processor optimized to handle machine learning operations, such as matrix manipulation. In one embodiment, to optimize processor 14 for machine learning, some and/or all components of memory 16 and/or I/O 18 can be made as integral components of the processor 14. For example, processor 14, memory 16 and/or I/O 18 can be implemented as a single multilayered IC. In other embodiments, a graphical processing unit (GPU) can be utilized to implement the processor 14.

The sensor 26 can include an electromagnetic detector. In some embodiments, the sensor 26 can include an antenna configured to receive reflected electromagnetic waves 25 reflected back from the targets 24, 34 and 36. The sensor 26 can include additional components such as a power supply, amplifier, tuner circuit, MEMs devices, micro motors, and/or components to receive the reflected electromagnetic waves 25. Similar to emitter 20, the sensor 26 can include processors, controllers, memory, storage and software/hardware to receive raw sensor 26 data associated with reflected electromagnetic waves 25 and generate a reflected signal dataset. The reflected signal dataset can include data such as received/detected currents and voltages, timing, frequency, wavelength, intensity, power and/or other relevant data.

The reflected signal dataset can include additional data, obtained from other sensors and detectors of the vessel 12. Such additional data can include, Global Positioning Signal data (GPS) (e.g., GPS coordinates) of the sensor 26, accelerometer data, speedometer data, inertial guidance/measurement system data, gyroscope data, gyrocompasses data and/or other associated data.

The transmitted and reflected signal datasets can be routed and inputted to the processor 14 via an I/O device/interface 18. The processor 14 can perform non-machine learning operations, machine learning operations, pre-processing, post-processing and/or other data operations to output an intermediate and/or final radar system output 30 using instructions stored on the storage 28. The radar output 30 can include a depth map and/or a radar point cloud, and/or other data structures which can be used to interpret distance or depth information relative to the targets 24, 34, 36. radar output 30 can be used for object detection, feature detection, classification, terrain mapping, topographic mapping and/or other 3D vision applications. A radar point cloud can be a data structure mapping GPS coordinates surrounding the radar system 10 to one or more datasets. An output of the radar system 10, such as a point cloud can be utilized to determine distance. While not the subject of the present disclosure, other components of vessel 12 may exist and can utilize the radar output 30 for various purposes, for example for objection detection and/or for performing machine learning to implement self-driving algorithms.

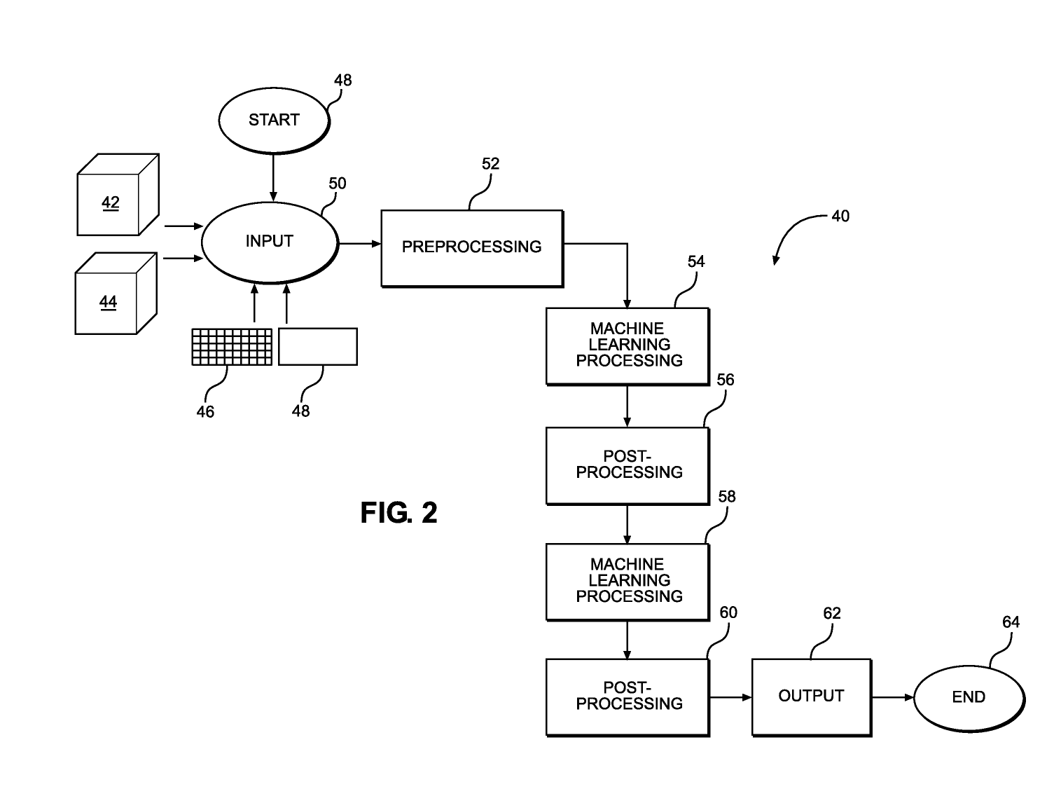

FIG. 2 illustrates an example radar data processing flow 40 according to an embodiment. Processor 14 can be configured to perform the process 40. The process 40 starts at the step 48. At the step 50, radar input data 42, 44, 46 and 48 are received. The input data 42 can include raw data from the emitter 20, for example, the transmitted signal dataset. Input data 44 can include raw data from the sensor 26, for example, the reflected signal dataset. Input data 46 and 48 can include raw data from other components of the vessel 12 and/or radar system 10 (e.g., GPS data, inertial system measurement data, accelerometer data, speedometer data, gyroscope data, gyrocompass data, etc.)

The process 40 then moves to the step 52 where preprocessing operations are performed. Examples of preprocessing operations include performing low level signal processing operations such as Fast Fourier Transform (FFT), filtering, and/or normalization. The process 40 then moves to the step 54, where one or more machine learning operations are used to process the raw or low-level-processed data from the emitter 20, sensor 26 and/or other components of the vessel 12. Example machine learning operations which can be used include, neural networks, convolutional neural networks (CNNs), generative adversarial networks, variational autoencoder, and/or other machine learning techniques. The process 40 then moves to the step 56, where post-processing operations can be performed. Post-processing operations can include similar operations to the pre-processing operations performed at the step 52 or can include other signal processing operations such as domain conversion/transformation, optimization, detection and/or labeling. In other embodiments, the post-processing step 56 can include operations to generate an output data structure suitable for machines, devices and/or processors intended to receive and act on the output of the radar system 10.

The process 40 then moves to the step 58 where further machine learning operations are performed. The machine learning operations of the step 58 can be similar to the machine learning operations of the step 54 or can include different classes of machine learning operations. The process 40 then moves to the step 60 where further post-processing operations can be performed on the resulting data. The process 40 then moves to the step 62 where radar output is generated. The process 40 then ends at the step 64.

In some embodiments, the pre-processing step 52, and the post-processing steps 56 and 60 can be optional. One and not the others can be performed. In some embodiments, the second machine learning operations 58 can be optional. In one embodiment, an intermediate radar output data structure may be extracted from the process 40 after the machine learning operations 54 and inputted into other systems and/or devices which can utilize the intermediate output of a radar system. In one embodiment, the intermediate radar system output contains a data structure (e.g., a point cloud from which a depth or distance map can be extracted). In some embodiments, the machine learning operations steps 54 and 58 can be configured to increase accuracy, resolution, smoothness and/or other desired characteristics of an intermediate and/or final output of a radar system (e.g., a point cloud).

In other embodiments, the first machine learning operations step 54 may be optional and the second machine learning operations step 58 may be performed instead. In some embodiments, desired output thresholds and tolerances can be defined and the process 40 and/or parts of it can be performed in iterations and/or loops until the desired thresholds and/or tolerances in the output are met. For example, while the process 40 is illustrated with performance of two machine learning operations steps 54 and 58, fewer or more machine learning operations steps may be used to achieve a desired characteristic in the output. For example, a desired resolution in a radar output point cloud may be achieved by performing one set of machine learning operations, such as those performed in the step 54. In other scenarios, more than two or three instances of machine learning operations on the radar input data may be performed to achieve a desired smoothness in the output point cloud. In autonomous vehicle applications where processing large amounts of radar input in a time efficient manner is desired, an intermediate radar output can be extracted after performing one machine learning operations step (e.g., machine learning operations of the step 54) to guide the autonomous driver algorithms in a timely manner.

The machine learning operations 54 and/or 58, and the machine learning models used therein, can be trained to improve their performance. For example, if a neural network model is used, it can be trained using backpropagation to optimize the model. In the context of radar output, training machine learning models can further improve the desired characteristics in the radar output.

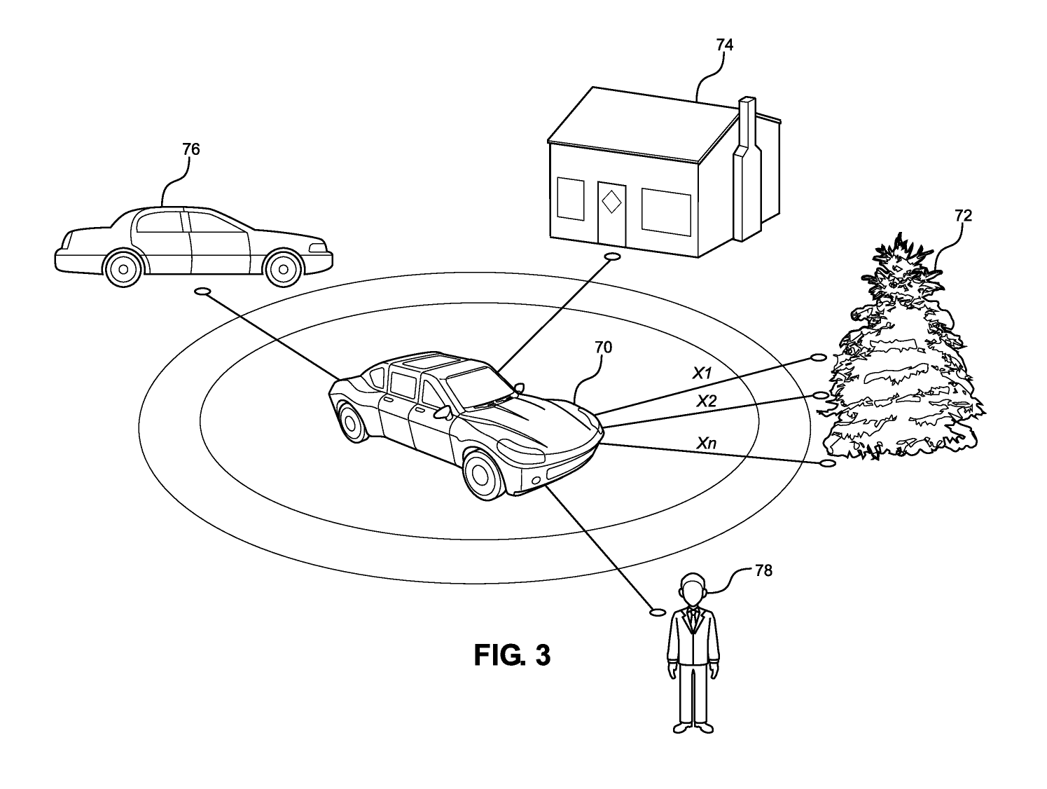

FIG. 3 illustrates an example application of the disclosed radar system and data processing. Vehicle 70, which can be an autonomous (e.g., a self-driving) vehicle is outfitted with the radar system 10. Targets 72, 74, 76 and 78 are in range. A variety of radar signal processing can be used to determine one or more distances x1, x2, . . . , xn from the target 72 and other objects (moving or stationary) around the vehicle 70. Example radar signal processing techniques to determine distances such as x1, x2, . . . , xn can include, time of flight measurements, measuring distance based on frequency modulation, measuring distance using speed measurement, and other techniques.

A 3D point cloud of distances from objects surrounding the vehicle 70 can be generated. Each object may yield hundreds or thousands of distances depending on the object size, surface shape and other factors. Nonetheless, the machine learning operations 54 and/or 58 can be used to extrapolate additional distances related to the objects 72, 74, 76 and 78 and augment any intermediate and/or final 3D point cloud or depth map with machine learning model driven distances, thus increasing the resolution, accuracy and smoothness of output point clouds.

The machine learning operations 54 and/or 58 can improve a radar output before it is outputted. For example, the machine learning operations 54 and/or 58 can denoise raw radar detector data using neural networks before generating a point cloud based on that data. In another embodiment, the machine learning operations 54 and/or 58 can increase the resolution of the radar output (e.g., a point cloud) before the output is sent to other machine learning processes that may be present within the vehicle 70.

The vehicle 70 can include other components, processors, computers and/or devices which may receive the output of the radar system 10 (e.g., a point cloud) and perform various machine learning operations as may be known by persons of ordinary skill in the art in order to carry out various functions of the vehicle 70 (e.g., various functions relating to self-driving). Such machine learning processes performed elsewhere in various systems of vehicle 70, while not the subject of the present disclosure, may be related, unrelated, linked or not linked to the machine learning operations performed in the radar system 10 and the embodiments described above. In some cases, machine learning processes performed elsewhere in the vehicle 70 may receive as their input an intermediate and/or final output of the radar system 10 as generated according to the described embodiments and equivalents thereof. In this scenario, the improved radar outputs generated according to the described embodiments can help components of vehicle 70, which receive the improved radar output, to more efficiently perform their functions.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first, second, other and another and the like may be used solely to distinguish one entity or action from another without necessarily requiring or implying any actual such relationship or order between such entities or actions.

The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various implementations. This is for purposes of streamlining the disclosure and is not to be interpreted as reflecting an intention that the claimed implementations require more features than are expressly recited in each claim. Rather, as the following claims reflect, inventive subject matter lies in less than all features of a single disclosed implementation. Thus, the following claims are hereby incorporated into the Detailed Description, with each claim standing on its own as a separately claimed subject matter.

What is claimed is:

1. A method of producing an output in a radar system, comprising:
transmitting electromagnetic waves toward a target, wherein the transmitted electromagnetic waves comprise a first dataset;
sensing reflected electromagnetic waves from the target, wherein the reflected electromagnetic waves comprise a second dataset;
performing machine learning operations on the first and second datasets to produce a first output, wherein the first output comprises distance information relative to the target.

2. The method of claim 1, wherein the output of the radar system comprises the first output.

3. The method of claim 2, wherein the first output comprises a point cloud, machine learning comprises one or more neural networks and the machine learning operations comprise one or more of increasing resolution, accuracy, and smoothness of the point cloud.

4. The method of claim 3, wherein the neural networks comprise one or more of convolutional neural network, generative adversarial network, and variational autoencoder.

5. The method of claim 1, wherein the machine learning operations are configured to reduce noise in the second dataset.

6. The method of claim 1 further comprising performing second machine learning operations on the first output to produce a second output, wherein the second output comprises distance information relative to the target.

7. The method of claim 6, wherein the output of the radar system comprises the second output.

8. The method of claim 7, wherein machine learning comprises one or more neural networks, the first machine learning operation comprises generating a point cloud and the second machine learning operation comprises refining resolution of the point cloud.

9. The method of claim 8, wherein the machine learning operations are configured to reduce noise in the second dataset.

10. The method of claim 1 further comprising training one or more machine learning models to improve one or more characteristics of the first output.

11. A radar system comprising:
an electromagnetic emitter source configured to transmit electromagnetic waves toward a target, wherein the transmitted electromagnetic waves comprise a first dataset;
an electromagnetic sensor configured to detect reflected electromagnetic waves from the target, wherein the reflected electromagnetic waves comprise a second dataset;
a machine learning processor configured to perform machine learning operations on the first and second datasets to produce a first output, wherein the first output comprises distance information relative to the target.

12. The system of claim 11 wherein an output of the radar system comprises the first output.

13. The system of claim 12, wherein the first output comprises a point cloud, the machine learning comprises one or more neural networks and the machine learning operations comprise increasing resolution of the point cloud.

14. The system of claim 13, wherein the neural networks comprise one or more of convolutional neural network, generative adversarial network, and variational autoencoder.

15. The system of claim 11, wherein the machine learning operations comprise reducing noise in the second dataset.

16. The system of claim 11, wherein the machine learning processor is further configured to perform second machine learning operations to produce a second output, wherein the second output comprises distance information relative to the target.

17. The system of claim 16, wherein an output of the radar system comprises the second output.

18. The system of claim 17, wherein machine learning comprises one or more neural networks, the first machine learning operations comprise generating a point cloud and the second machine learning operations comprise one or more of increasing resolution, accuracy and smoothness of the point cloud.

19. The system of claim 18, wherein the machine learning operations comprise reducing noise in the second dataset.

20. The system of claim 18, wherein the machine learning processor is further configured to train one or more machine learning models.
